(19) United States
(12) Patent Application Publication
(10) Pub. No.: US 2009/0021867 A1
(43) Pub. Date: Jan. 22, 2009

(54) Magnetic disk drive for controlling flying height of magnetic head

(75) Inventors: Masao Kondo, Kawasaki (JP); Shigeyoshi Umemiya, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/999,348

(22) Filed: Dec. 5, 2007

(30) Foreign Application Priority Data
Dec. 22, 2006 (JP) 2006-346760

(51) Int. Cl. G11B 21/24

(52) U.S. Cl. 360/294; G9B/21.028

(57) ABSTRACT

A magnetic disk drive includes a magnetic head, a magnetic disk, an actuator for changing the position of the magnetic head with respect to the magnetic disk, a sensor for detecting vibration of the magnetic head; and a controller for detecting contact between the magnetic head and the magnetic disk on the basis of the detected vibration and for controlling the actuator.

### BACKGROUND OF THE INVENTION

1. Field of the Invention

The present invention relates to a magnetic disk drive capable of precisely controlling the flying height of a magnetic head, and a method for controlling the flying height of the magnetic head.

2. Description of the Related Art

In magnetic disk drives (hard disk drives (HDD)), technological improvements of magnetic disks, magnetic heads, signal processing, and the like have increased capacity in a very high growth rate, thereby leading to a finer track pitch. In this situation, in the case of a magnetic disk drive including a flying head, holding the minute flying height of the magnetic head constant is important for the improvement of reliability.

A slider on which the magnetic head is mounted is used to float the magnetic head. The slider receives airflow generated by the rotation of the magnetic disk to allow the magnetic head to float in an appropriate flying height. The flying height of the magnetic head is affected by the shape of the slider because of such a mechanism. Thus, variations in flying height disadvantageously occur among drives. Furthermore, the flying height of the magnetic head disadvantageously changes in response to a change in atmospheric pressure.

To overcome the foregoing problem of the variations in the flying height of the magnetic head, Japanese Unexamined Patent Application Publication No. 06-267219 discloses a method for adjusting the flying height by means for adjusting a lifting force acting on the magnetic head. According to the patent document, the magnetic disk drive described in the patent document includes a piezoelectric element in a slider. The deformation of the piezoelectric element is controlled in response to an operation mode. The deformation of the piezoelectric element deforms the shape of the slider (amount of crown) to change the lifting force acting on the magnetic head.

In the magnetic disk drive disclosed in the patent document, the flying height of the magnetic head is controlled by adjusting the lifting force acting on the magnetic head. Thus, in the art disclosed in the patent document, variations in the flying height of the magnetic head due to the operation mode and environmental factors can be reduced. However, the flying height of the magnetic head with respect to the surface of the magnetic disk cannot be controlled. That is, disadvantageously, the absolute value of the flying height of the magnetic disk cannot be precisely controlled.

### SUMMARY

According to an aspect of an embodiment, a magnetic disk drive includes: a magnetic head; a magnetic disk; an actuator for changing the position of the magnetic head with respect to the magnetic disk; a sensor for detecting vibration of the magnetic head; and a controller for detecting contact between the magnetic head and the magnetic disk on the basis of the detected vibration and for controlling the actuator.

### BRIEF DESCRIPTION OF THE DRAWINGS

FIG. 1 shows a schematic structure of a magnetic disk drive according to a first embodiment of the present invention;

FIG. 2 is a flowchart of a method for adjusting the flying height of a magnetic head;

FIGS. 3A to 3C show states of a head unit 20 in main steps shown in the flowchart in FIG. 2;

FIGS. 4A and 4B are each a graph showing an example of a signal 11c supplied from a filter circuit 14;

FIG. 5A is a graph showing the relationship between the energy input to a heater 70 and the flying height of a magnetic head, and FIG. 5B is a graph showing the relationship between the energy input to the heater 70 and the signal strength;

FIGS. 6A and 6B each show an example of a structure in which a sensor 50 is disposed at position A;

FIGS. 7A and 7B each show an example of a structure in which the sensor 50 is disposed at position B;

FIGS. 8A and 8B each show an example of a structure in which the sensor 50 is disposed at position C;

FIG. 9 is an enlarged view of the head unit 20;

FIGS. 10A and 10B each show a structure of the sensor 50;

FIGS. 11A to 11C show step (1) of producing the sensor 50 according to the embodiment;

FIG. 12 shows step (2) of producing the sensor 50 according to the embodiment;

FIG. 12D is a partial diagrammatic view of the step (2);

FIGS. 13E and 13F show step (3) of producing the sensor according to the embodiment;

FIGS. 14G and 14H show step (4) of producing the sensor according to the embodiment;

FIGS. 15I and 15J show step (5) of producing the sensor according to the embodiment;

FIG. 16 shows the production process of the sensor 50

FIGS. 17A to 17C show an exemplary method for adjusting the flying height of a magnetic head 30 by vertically moving an arm 22 of the head unit 20.

### DESCRIPTION OF THE PREFERRED EMBODIMENTS

Embodiments of the present invention will be described in detail below with reference to the drawings.

### First Embodiment

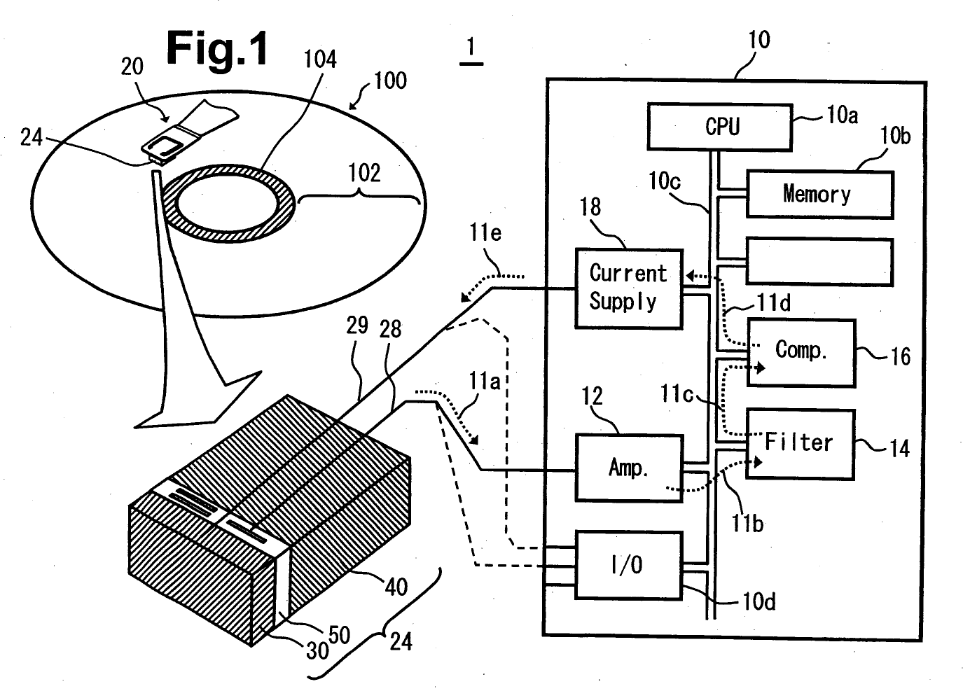

FIG. 1 shows a schematic structure of a magnetic disk drive according to a first embodiment of the present invention. As shown in FIG. 1, a head unit 20 reads data from a magnetic disk 100 and writes data into the magnetic disk 100. The head unit 20 includes a slider 24. The slider 24 includes a magnetic head 30 and a sensor 50 on a substrate 40 as shown in FIG. 1. The magnetic disk 100 has a storage region 102 capable of storing data and a non-storage region 104 in which data is not stored.

The magnetic head 30 reads data from the magnetic disk 100 and writes data into the magnetic disk 100, as described above. The magnetic head 30 includes a read head element (not shown) that reads data from the magnetic disk 100 and a write head element (not shown) that writes data into the magnetic disk 100. The magnetic head 30 also includes a heater (not shown) that produces heat by being supplied with a current so as to protrude a surface of the slider 24 facing the magnetic disk 100. The heater is supplied with a current from a current supply circuit 18 in a controller 10. The heater produces heat in response to the amount of current supplied so as to expand the bottom of the slider 24 facing the magnetic disk 100. The expansion of the bottom of the slider 24 reduces the distance between the surface of the magnetic disk 100 and an end of the read head element adjacent to the magnetic disk 100 and between the surface of the magnetic disk 100 and an end of the write head adjacent to the magnetic disk 100. That is, the position of the magnetic head 30 with respect to the surface of the magnetic disk 100 shifts in response to the amount of current (amount of energy) fed into the heater. In this case, the position of the slider 24 with respect to the surface of the magnetic disk 100, i.e., the flying height of the slider, does not shift substantially. The amount of protrusion of the bottom of the slider 24 is equal to the amount of displacement of the magnetic head 30. A specific arrangement of the read head, the write head, and the heater will be described below.

As stated above, a part that changes the position of a magnetic head with respect to a magnetic disk is also referred to as an “actuator”.

The sensor 50 is disposed between the substrate 40 and the magnetic head 30. The sensor 50 converts mechanical vibration of the slider 24 into an electric signal 11a. The electric signal 11a is transmitted to a signal amplifying circuit 12 in the controller 10 through a lead 28.

The controller 10 is mounted on, for example, a control board (not shown) that controls operations of a magnetic disk drive 1. As shown in FIG. 1, the controller 10 includes a central processing unit (CPU 10a), a memory 10b in which a program for controlling the CPU 10a is stored, and a bus 10c that transmits signals therebetween. The controller 10 controls operations of the magnetic disk drive 1. The controller 10 includes an input/output circuit 10d which is connected to the bus 10c and which sends a signal to the outside and receives a signal from the outside. The memory 10b includes a random-access memory (RAM) that temporarily stores data and a read-only memory (ROM) holding a program. Furthermore, the controller 10 includes the signal amplifying circuit 12, a filter circuit 14, a comparator circuit 16, and the current supply circuit 18 that are connected to the CPU 10a through the bus 10c.

The signal amplifying circuit 12 receives the electric signal 11a from the sensor 50 and then amplifies the electric signal 11a according to a command from the CPU 10a. Alternatively, the signal amplifying circuit 12 does not directly receive the electric signal 11a but may receive the electric signal 11a via the input/output circuit 10d. The amplified signal 11b is send to the filter circuit 14 through, for example, the bus 10c. For example, the signal amplifying circuit 12 amplifies the voltage level of the electric signal 11a while the S/N ratio of the electric signal 11a is maintained. The amplification operation of the electric signal 11a may be performed not by the command from the CPU 10a but with the signal amplifying circuit 12 alone.

The filter circuit 14 receives the signal 11b from the sensor 50 and then filters the signal 11b. The filter circuit 14 sends the filtered signal 11c to the comparator circuit 16 through, for example, the bus 10c. For example, the filter circuit 14 filters out frequency components of several tens of kilohertz or less and frequency components of several megahertz or more to improve the S/N ratio of the amplified signal 11b. The filtering of the signal 11b may be performed not by a command from the CPU 10a but with the filter circuit 14 alone.

The comparator circuit 16 receives the signal 11c from the filter circuit 14. The comparator circuit 16 compares a peak value of the signal 11c with a reference value according to a command from the CPU 10a. The comparator circuit 16 provides a notification 11d of the comparison result to the current supply circuit 18. Specifically, when the peak value of the signal 11c is larger than the predetermined reference value, the notification 11d is made to the current supply circuit 18. The notification 11d to the current supply circuit 18 is made through, for example, the bus 10c. The comparison of the peak value of the signal 11c with the reference value may be performed not by a command from the CPU 10a but with the comparator circuit 16 alone.

The term “reference value” defined here refers to a value determined by actual measurement of a plurality of magnetic disk drives 1 that are of the same type. Specifically, in each of the magnetic disk drives 1 prepared, the magnetic head 30 is brought into contact with a surface of the magnetic disk 100. The signal 11c is measured before contact. Then the signal 11c is measured when the magnetic head 30 is in contact with the surface of the magnetic disk 100. A frequency component of the signal 11c having a largest change in peak value is determined from the measurement results. A substantially intermediate value between the peak value before contact and the peak value of the determined frequency component when the magnetic head 30 is in contact with the surface of the magnetic disk 100 is defined as the reference value. Alternatively, the reference value may be determined by a simulation. In addition, the reference value may be determined by the use of the magnetic disk drive 1 in which the flying height of the magnetic head 30 will be adjusted. In this case, for example, the housing (not shown) of the magnetic disk drive 1 is provided with a small transparent window (not shown). After the completion of the magnetic disk drive 1, vibration of the magnetic head 30 is observed through the transparent window in order to determine when the magnetic head 30 comes into contact with the magnetic disk 100. In the case where vibration of the magnetic head 30 is observed through the transparent window, a measuring apparatus, such as a laser Doppler vibrometer that irradiates an object with laser light and measures a relative velocity on the basis of the phase difference of the reflected light may be used.

The current supply circuit 18 receives the notification 11d from the comparator circuit 16 and then limits the value of a current 11e fed into the heater. For example, the ROM in the controller 10 stores the relationship between the current 11e fed into the heater and the flying height of the magnetic head 30. The relationship between the current 11e fed into the heater and the flying height of the magnetic head 30 is desirably obtained by measurement with the magnetic disk drive 1 in which the flying height will be adjusted. Thus, for example, the relationship is determined by automatically performing measurement immediately after power-on and writing the measurement result into the ROM at a predetermined address. Alternatively, the relationship determined by a simulation may be written from the outside into the ROM at a predetermined address. The CPU 10a may carry out all of these tasks on the basis of a program stored in the ROM. In addition, the current 11e fed into the heater may be a pulse current.

When the current supply circuit 18 receives the notification 11d from the comparator circuit 16, the current supply circuit 18 recognizes that the magnetic head 30 is in contact with the surface of the magnetic disk 100. The current supply circuit 18 allows the value of current fed into the heater (for example, the value of the current 11e) when the current supply circuit 18 receives the notification to be temporarily stored into the RAM in the controller 10 according to a command from the CPU 10a. In the case where the current 11e fed into the heater is a pulse current, for example, the current supply circuit 18 regards the integral of the current per unit time as the value of the current 11e fed and allows the integral to be stored into the RAM. In addition, the CPU 10a may carry out all of the storage tasks on the basis of a program stored in the ROM. Then, according to commands from the CPU 10a, the current supply circuit 18 determines a current Is corresponding to an optimum flying height Hs from the value of the current 11e when the magnetic head 30 is in contact with the surface of the magnetic disk 100, and sets the current fed into the heater to the current Is. When a read operation and a write operation are performed, the current Is is fed into the heater through a lead 29. In this case, the current 11e fed into the heater is not directly supplied from the current supply circuit 18 but may be supplied from the current supply circuit 18 via the input/output circuit 10d.

### Method for Adjusting Flying Height of Magnetic Head

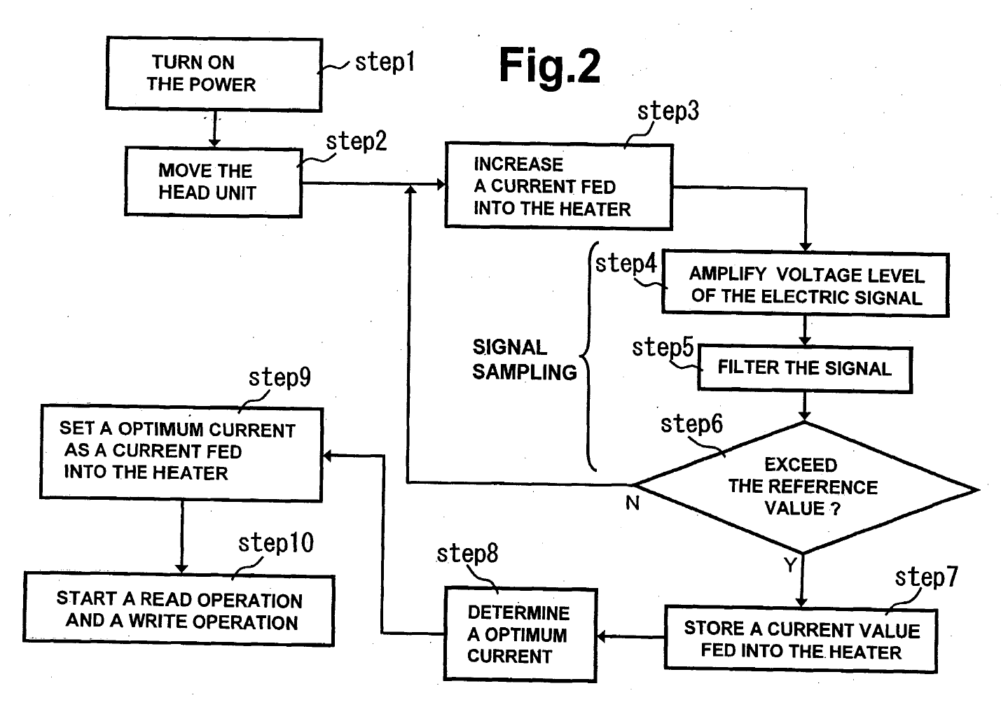

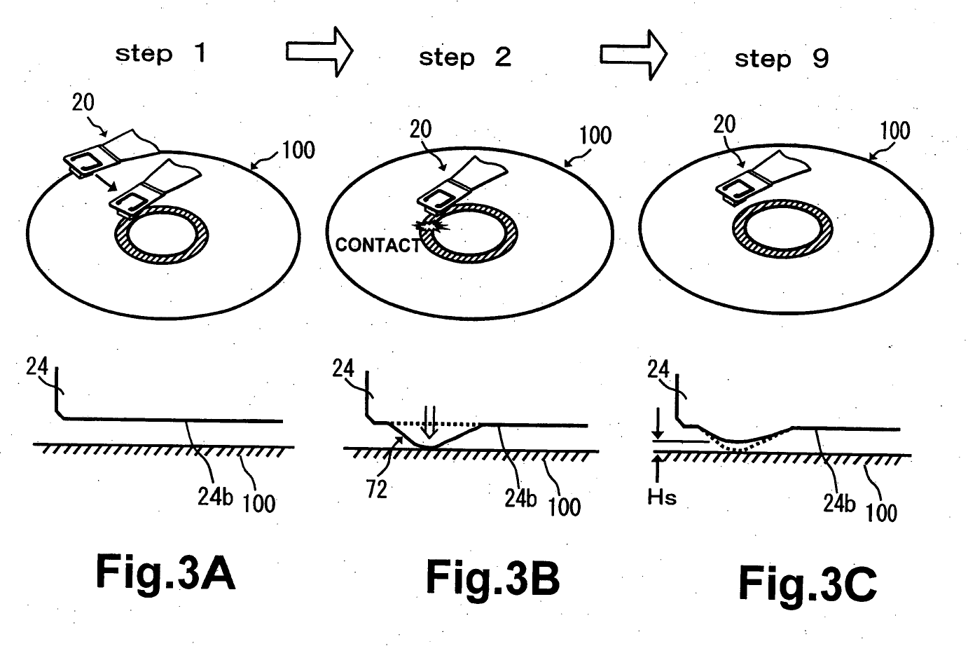

A method for adjusting the flying height of the magnetic head with the magnetic disk drive 1 shown in FIG. 1 will be described below. FIG. 2 is a flowchart of the method for adjusting the flying height of the magnetic head. FIGS. 3A to 3C show states of the head unit 20 in main steps shown in the flowchart in FIG. 2.

### Step 1

The power to the magnetic disk drive 1 is turned on. Then the CPU 10a in the controller 10 rotates a spindle on which the magnetic disk 100 is mounted to rotate the magnetic disk 100.

### Step 2

The controller 10 moves the head unit 20 in such a manner that the magnetic head 30 is located directly above the non-storage region 104 of the magnetic disk 100. Specifically, for example, the head unit 20 is moved in the direction of an arrow shown in FIG. 3A. The head unit 20 may be moved before the rotation of the magnetic disk 100. Alternatively, the head unit 20 may be moved above a specific track in the storage region 102 of the magnetic disk 100, provided that data is not read from and written into the track to be brought into contact with the magnetic head 30.

### Step 3

The CPU 10a increases a current fed into the heater in the magnetic head 30 by a predetermined increment. A current equal to the predetermined increment is fed into the heater because the current fed into the heater is initially zero. In the case where this step is performed after step 6 is performed, the current fed into the heater is gradually increased. The heater protrudes the bottom 24b of the slider 24 toward the magnetic disk 100 in response to the current fed. FIG. 3B shows this state. Although FIG. 3B shows the state (protrusion 72) in which the bottom 24b protrudes partially, a wider region of the bottom 24b may protrude. However, in each case, the most protruded portion preferably corresponds to the bottom of the magnetic head 30.

### Step 4

The CPU 10a starts sampling the electric signal 11a from the sensor 50. The CPU 10a commands the signal amplifying circuit 12 to amplify the voltage level of the electric signal 11a from the sensor 50 and then to send the amplified signal 11b to the filter circuit 14.

### Step 5

The CPU 10a commands the filter circuit 14 to filter the signal 11b from the signal amplifying circuit 12 and then to send the filtered signal 11c to the comparator circuit 16. As described above, for example, the S/N ratio of the amplified signal 11b is improved by filtering out frequency components of several tens of kilohertz or less and frequency components of several megahertz or more. Alternatively, a plurality of magnetic disk drives 1 that are of the same type is tested in order to determine a frequency component required, and then frequency components other than the determined frequency component may be filtered out.

### Step 6

The CPU 10a allows the comparator circuit 16 to check whether the strength of the signal 11c exceeds the reference value. When the strength of the signal 11c does not exceed the reference value, the CPU 10a gives a command to return to Step 3. When the strength of the signal 11c exceeds the reference value, the CPU 10a commands the comparator circuit 16 to provide notification of an excess of the strength of the signal 11c over the reference value to the current supply circuit 18. Then the CPU 10a gives a command to go to Step 7. Alternatively, only when the strength of the signals 11c exceeds the reference value multiple times (e.g., three times) in succession, the process may go to step 7. This process ensures reliable determination impervious to noise.

### Step 7

The CPU 10a commands the current supply circuit 18 to store the current value Ic (collision energy E2) fed into a heater 70 when the strength of the signal 11c exceeds the reference value into the RAM in the memory 10b.

### Step 8

The CPU 10a determines the optimum current Is (optimum energy level E1) on the basis of the relationship between the current 11e fed into the heater and the flying height of the magnetic head 30, the relationship being stored in the ROM in advance.

### Step 9

The CPU 10a commands the current supply circuit 18 to set the current 11e fed into the heater at the optimum current Is (optimum energy level E1) determined in Step 8.

### Step 10

The CPU 10a reads data (read operation) from the magnetic disk 100 and writes data (write operation) into the magnetic disk 100 while the optimum current Is is fed into the heater. FIG. 3C shows this state.

The flying height of the magnetic head 30 is controlled through the above-described steps. The above-described control precisely adjusts the flying height of the magnetic head with respect to the surface of the magnetic disk. In the case where the relationship between the flying height of the magnetic head 30 and the current 11e fed into the heater 70 in the read operation is different from that in the write operation, the adjustment of the flying height of the magnetic head 30 in the read operation may be different from that in the write operation. Furthermore, in Steps 3 to 6, processing may be performed by each circuit without a command from the CPU 10a.

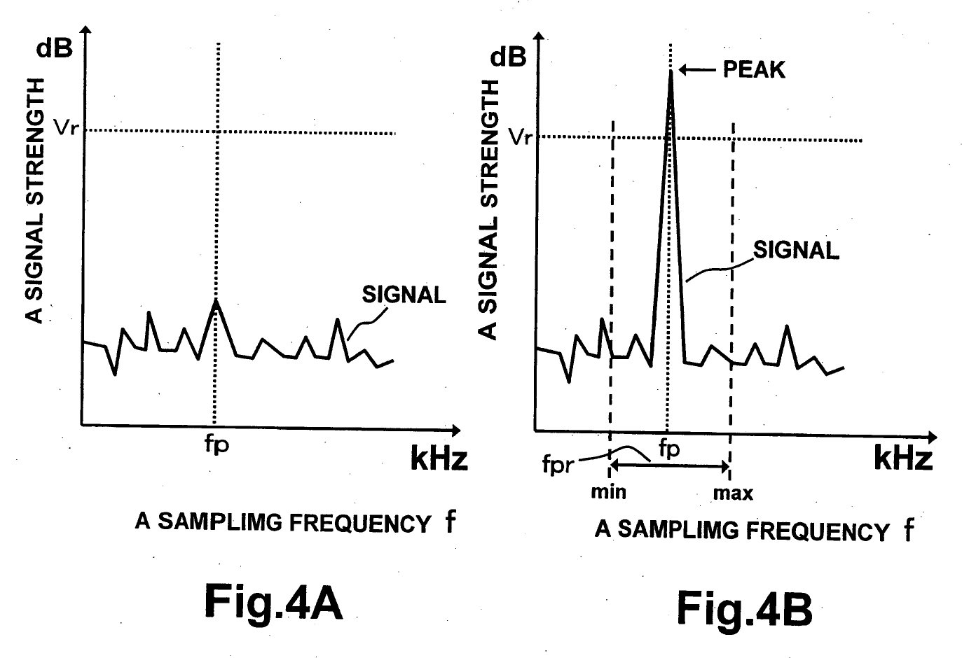

A method for detecting a point (reference point of the flying height) where the magnetic head 30 is in contact with the magnetic disk 100 on the basis of a sampled signal waveform will be described below. FIGS. 4A and 4B are each a graph showing an example of a signal 11c supplied from a filter circuit 14. FIG. 4A shows a signal sampled before the magnetic head 30 comes into contact with the magnetic disk 100. FIG. 4B shows a signal sampled immediately after the magnetic head 30 comes into contact with the magnetic disk 100. In FIGS. 4A and 4B, the horizontal axis indicates the sampling frequency, and the Vertical axis indicates the signal strength.

The contact between the magnetic head 30 and the surface of the magnetic disk 100 steeply increases only a signal component having a predetermined frequency (fp). As a result, the peak value of the signal having the predetermined frequency fp exceeds the reference value. In this way, a frequency component that is maximized when the magnetic head 30 is in contact with the magnetic disk 100 is defined as the predetermined frequency. The predetermined frequency fp is a value determined in response to, for example, the shape of the slider 24. Thus, the predetermined frequency fp can vary slightly among devices that are of the same type. As shown in FIG. 4B, the minimum (min) and the maximum (max) of the variation range fpr of the predetermined frequency fp may be set.

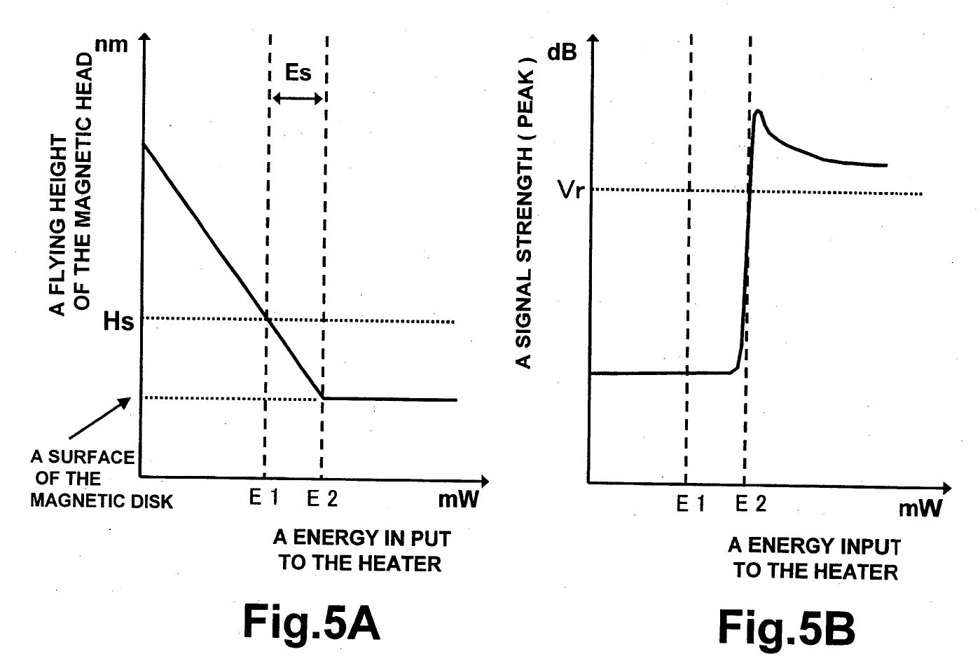

FIG. 5A is a graph showing the relationship between the energy input to the heater 70 and the flying height of the magnetic head, and FIG. 5B is a graph showing the relationship between the energy input to the heater 70 and the signal strength. The term “flying height of the magnetic head” refers to the flying height of the magnetic head 30 with respect to the magnetic disk 100. The term “signal strength” refers to the signal strength of the predetermined frequency fp of the signal 11c. As shown in FIG. 5A, an increase in energy input to the heater 70 gradually reduces the flying height of the magnetic head 30. When the energy input reaches E2, the flying height of the magnetic head 30 is zero. That is, the bottom of the magnetic head 30 (slider 24) comes into contact with the surface of the magnetic disk 100. As shown in FIG. 5B, the signal strength (peak value) of the signal 11c increases steeply and exceeds the reference value Vr.

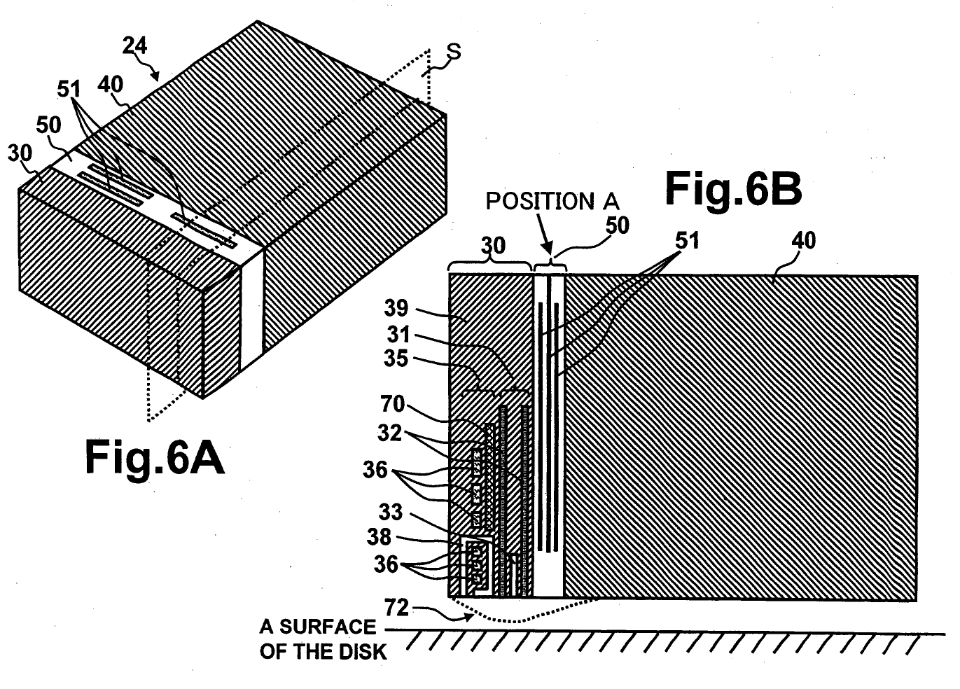

Examples of a structure in which the sensor 50 is mounted on the slider 24 will be shown. FIGS. 6A and 6B each show an example of a structure in which the sensor 50 is disposed between the substrate 40 and the magnetic head 30 (position A). As shown in FIGS. 6A and 6B, the sensor 50 includes a plurality of electrodes for obtaining an electric signal. FIG. 6A is a perspective view of the slider 24. FIG. 6B is a cross-sectional view of the slider 24, viewed along the plane S. As shown in FIG. 6B, the magnetic head 30 includes a read head element 31 and a write head element 35 therein. The read head element 31 includes two shield layers 32 and a read subelement between the shield layers 32. The write head element 35 includes a write coil 36 and a magnetic pole 38 magnetized by the write coil 36. The magnetic head 30 further includes the heater 70 disposed between the write coil 36 and the magnetic pole 38. The main components (the read head element 31, the write head element 35, and the heater 70) of the magnetic head are covered with a protective film 39 as shown in the figure.

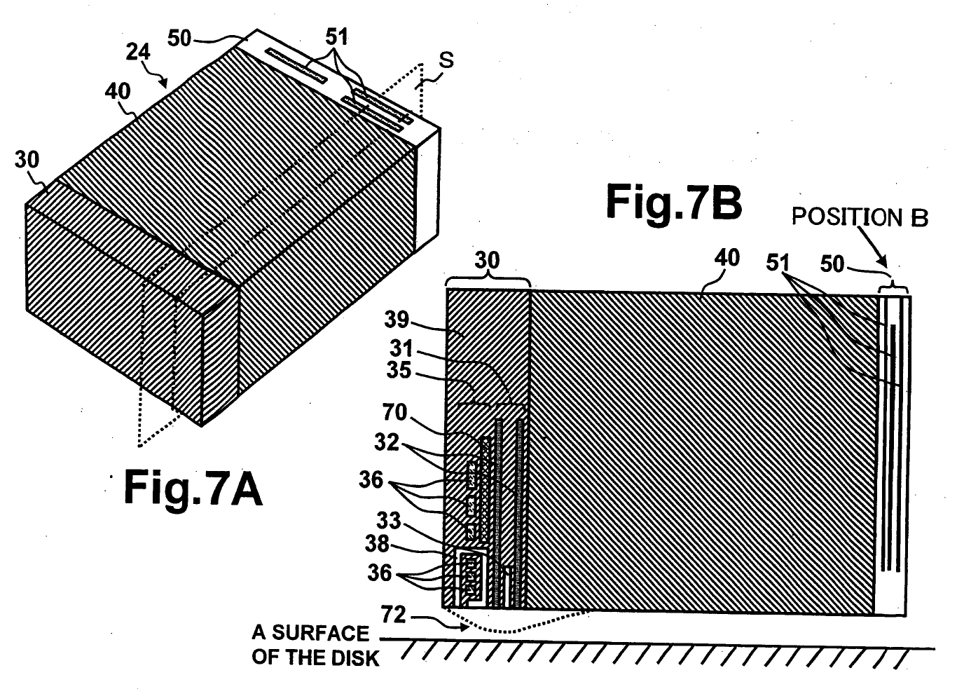

FIGS. 7A and 7B each show an example of a structure in which the sensor 50 is disposed on a side (position B) of the substrate 40 opposite the side adjacent to the magnetic head 30. FIG. 7A is a perspective view of the slider 24. FIG. 7B is a cross-sectional view of the slider 24, viewed along the plane S. The structure in the magnetic head 30 is the same as in FIGS. 6A and 6B, and redundant description is not repeated.

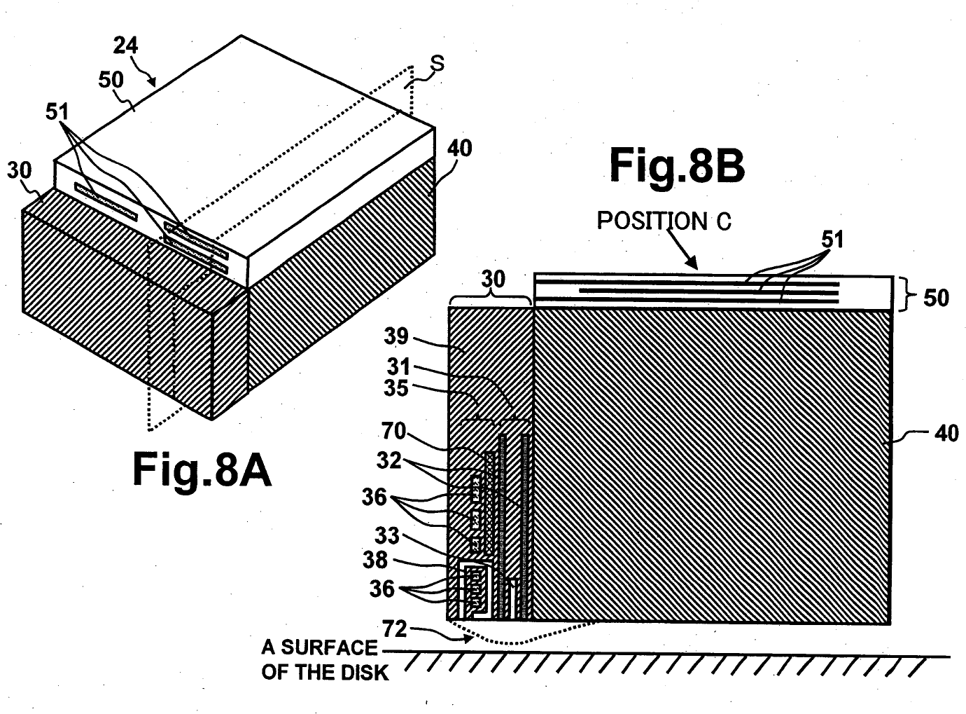

FIGS. 8A and 8B each show an example of a structure in which the sensor 50 is disposed on the top face (position C) of the substrate 40. FIG. 8A is a perspective view of the slider 24. FIG. 8B is a cross-sectional view of the slider 24, viewed along the plane S. The structure in the magnetic head 30 is the same as in FIGS. 6A and 6B, and redundant description is not repeated. When the sensor 50 is disposed at position C, the sensor 50 can have a large area compared with the case where the sensor 50 is disposed at positions A or B. Thus, the structure is advantageous in that sensitivity to a signal (S/N ratio) can be increased because vibration of the slider 24 can be detected with the large-area sensor. FIGS. 8A and 8B each show the example of the structure in which the electrodes of the sensor 50 are located on the magnetic head 30 side. When a space around the magnetic head 30 is not easily ensured because of the presence of leads from the magnetic head 30, the electrodes may be located on a side opposite the magnetic head 30 side.

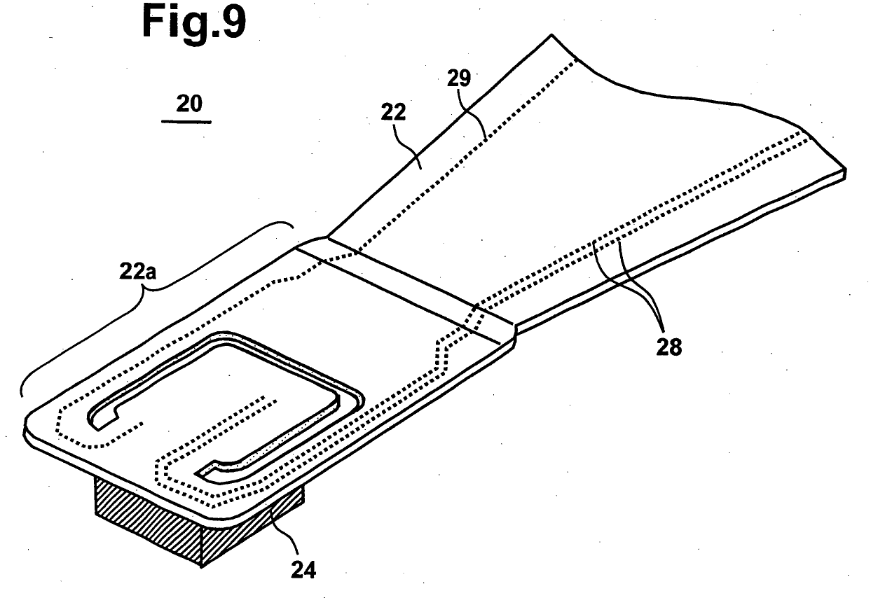

FIG. 9 is an enlarged view of the head unit 20. The slider 24 is mounted on an end of the arm 22 (arm end 22a). As shown in the figure, for example, the leads 28 and 29 from the slider 24 are disposed on the undersurface of the arm 22 and electrically connects between a plurality of electrodes (not shown) disposed on the slider 24 and the controller 10. A flexible wiring board (not shown) provided with the leads 28 and 29 may be attached to the arm 22 instead of the leads 28 and 29 directly formed on the undersurface of the arm 22.

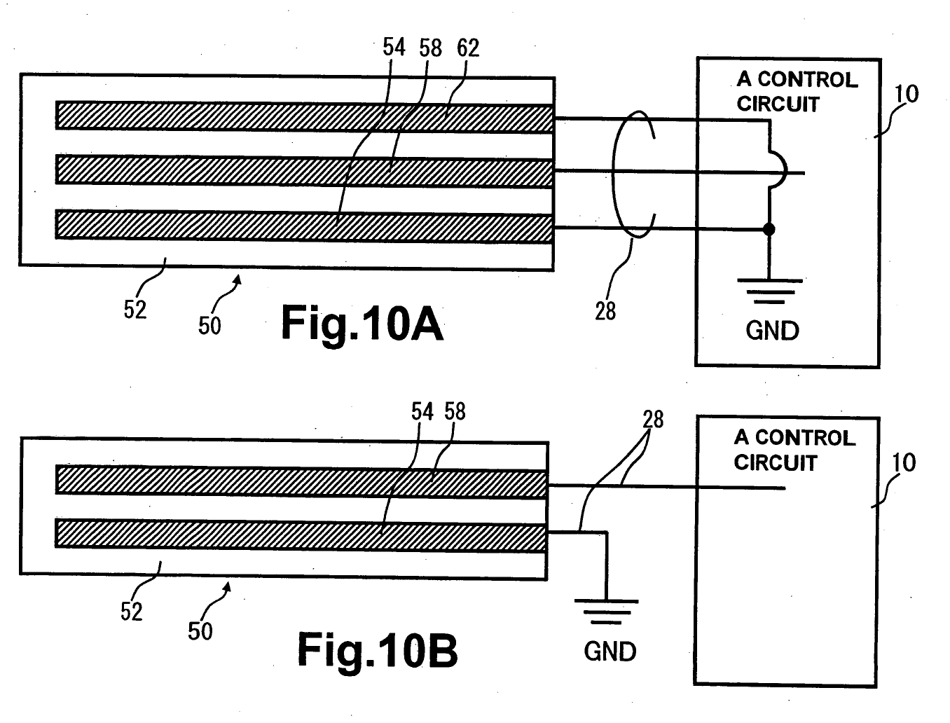

FIGS. 10A and 10B each show a basic structure of the sensor 50. As shown in FIG. 10A, the sensor 50 is composed of electrodes 54, 58, and 62 and an insulating layer 52. As described above, the insulating layer 52 is composed of an insulating material, such as aluminum nitride, having piezoelectricity. FIG. 10B shows an example of a structure in which a single electrode is grounded.

As shown in FIG. 10A, the electrodes 54 and 62 may be connected to the lead 28 extending from the controller 10 to establish a ground. Alternatively, as shown in FIG. 10B, the electrode 54 may be connected to a position other than the controller 10 to establish a ground.

### Process for Producing Slider

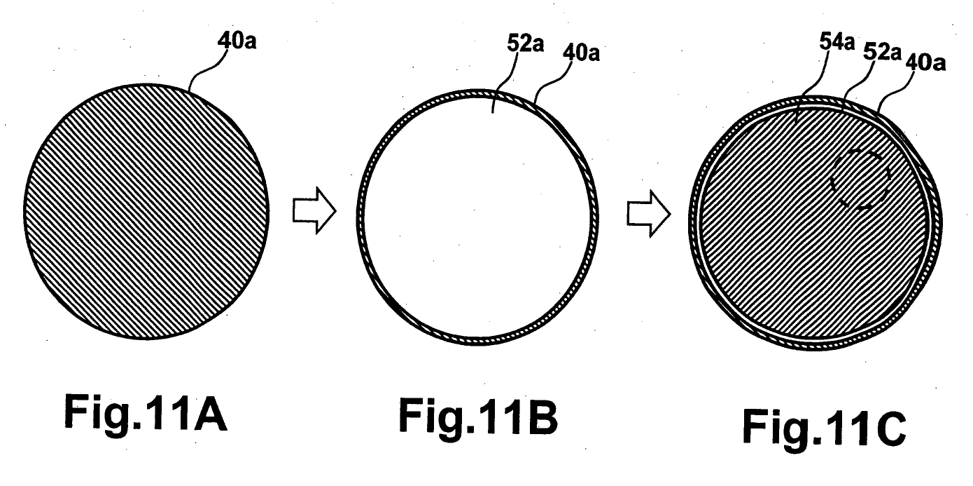

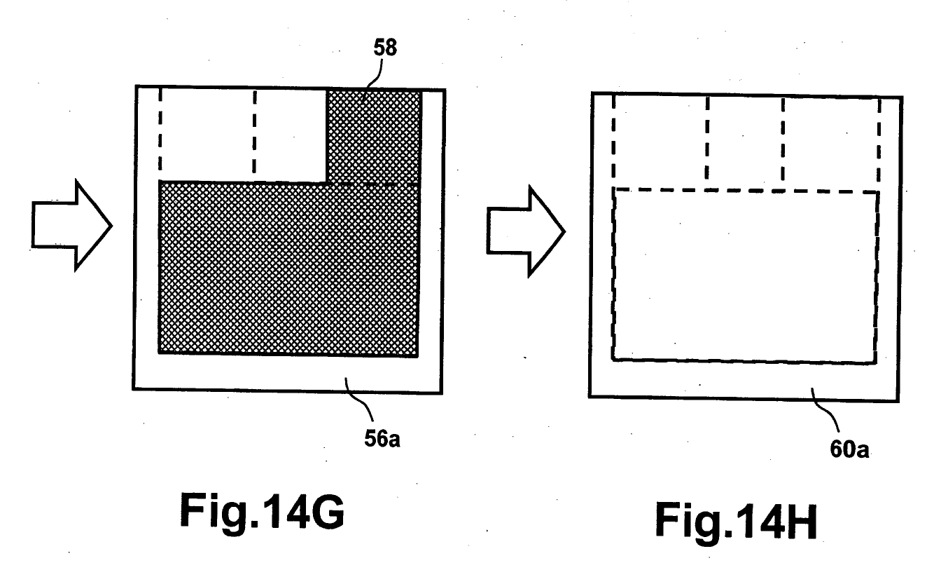

An outline of a process for producing the slider 24 according to the first embodiment will be described below. In particular, a process for producing the sensor 50 will be described in detail. FIGS. 11A to 15J show the process for producing the sensor 50 according to this embodiment.

As shown in FIG. 11A, a wafer substrate 40a composed of AlTiC is prepared. AlTiC is a ceramic material prepared by firing a mixture of alumina (Al₂O₃) and titanium carbide (TiC).

As shown in FIG. 11B, an aluminum nitride (AlN) film 52a is formed on one surface of the substrate 40a by RF sputtering. In this step, the temperature is set at 250° C. When the aluminum nitride film 52a is formed while the temperature is maintained at 250° C., a piezoelectric film oriented in the [001] direction can be formed.

As shown in FIG. 11C, an aluminum (Al) film 54a is formed on the aluminum nitride film 52a.

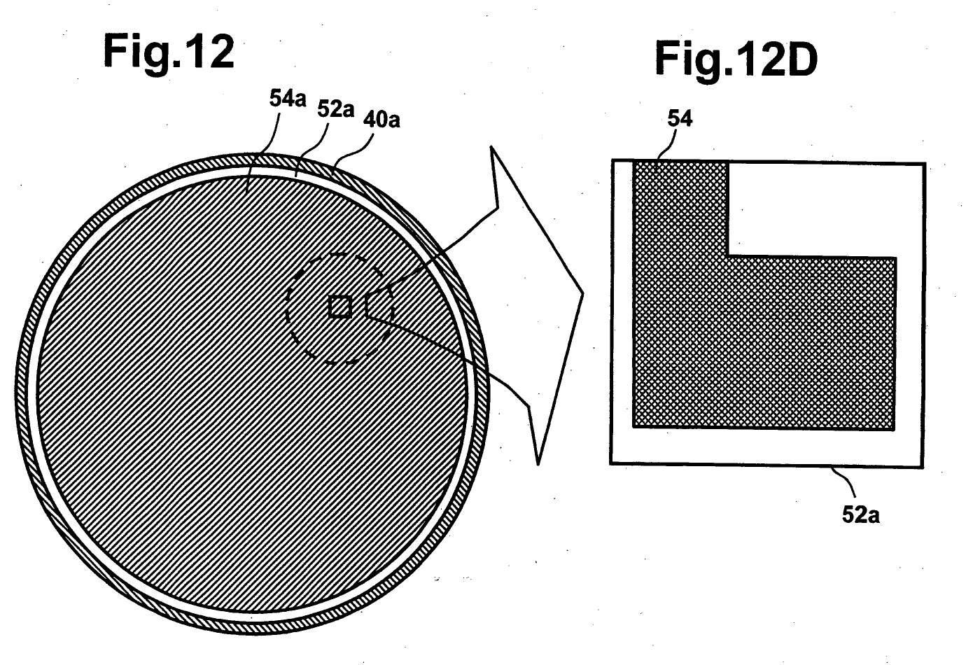

As shown in FIG. 12D, the aluminum film 54a is patterned to form the electrode 54. In this case, for example, a resist film (not shown) is formed on the aluminum nitride film 52a and is then patterned by photolithography. Alternatively, the formation of the electrode 54 shown in FIGS. 11C and 12D may be performed by a lift-off method. In the case where the lift-off method is employed, a resist film (not shown) is first patterned to form an opening having the same shape as the electrode 54. Then an aluminum film having a thickness of about 200 nm is formed on the entire surface by sputtering. Finally, the aluminum film is patterned by the lift-off method to form the electrode 54.

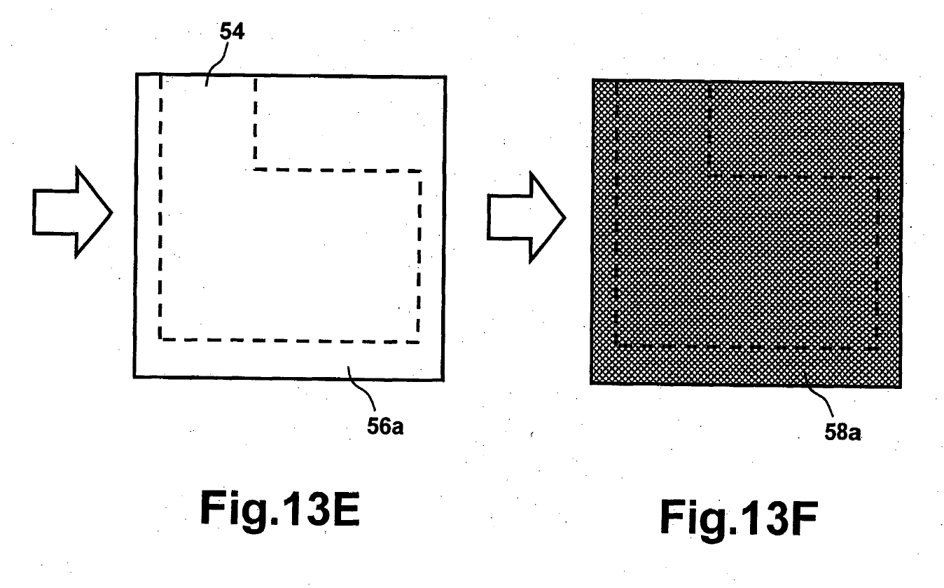

Steps shown in FIGS. 13E to 15I are performed in the same way as the steps shown in FIGS. 11B to 12D, thereby forming an aluminum nitride film 56a, an aluminum film 58a, an electrode 58, an aluminum nitride film 60a, an aluminum film 62a (not shown), and an electrode 62.

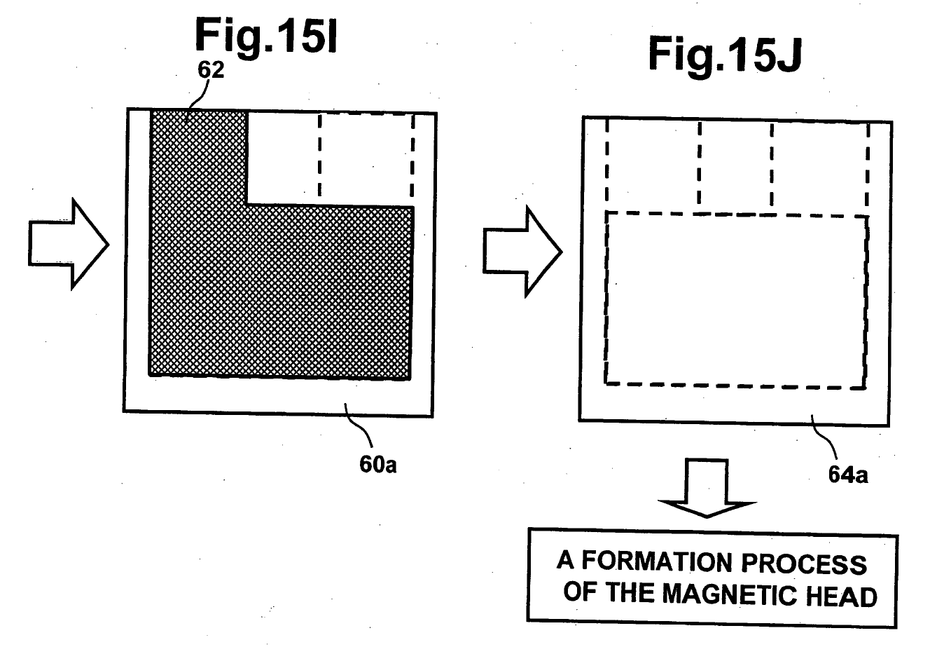

As shown in FIG. 15J, an aluminum nitride film 64a is formed in the same way as the step shown in FIG. 11B. Then a protective film (not shown), such as a resist film, is formed on one surface of the substrate 40a (the sensor 50 side) to complete the sensor 50.

The other surface of the substrate 40a (a side opposite the sensor 50 side) is cleaned. Then the magnetic head 30 is formed on the other surface.

The substrate 40a is separated into the sliders 24 by dicing. Each of the separated sliders 24 is mounted on the arm end 22a. The arm end 22a has spring properties and thus is also referred to as a “suspension”. The electrodes 54 and 62 (ground electrodes) and the electrode 58 (sensor electrode) of the sensor 50 are connected to the lead 28 formed on the arm end 22a. Alternatively, the substrate 40 of the slider 24 may be connected to a ground, and the electrodes 54 and 62 may be connected to the substrate 40.

The above-described steps are steps in the case where the sensor 50 is disposed at position B (FIGS. 7A and 7B). Also in the case where the sensor 50 is disposed at position A (FIGS. 6A and 6B), the slider 24 can be produced through steps substantially the same as the steps in the case where the sensor 50 is disposed at position B.

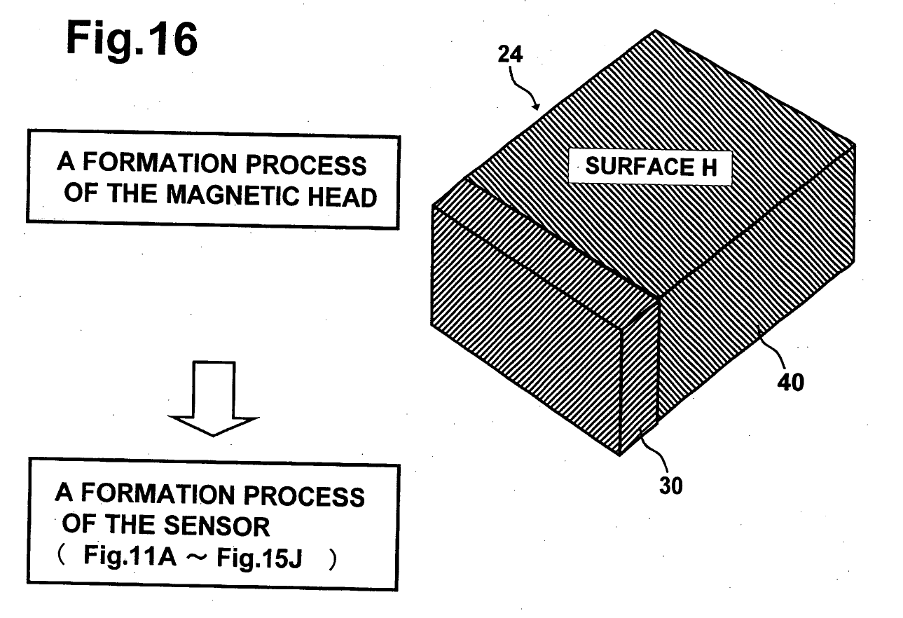

In the case where the sensor 50 is disposed at position C (FIGS. 8A and 8B), for example, the slider 24 is produced by a step shown in FIG. 16. The magnetic head 30 is formed on the substrate 40a composed of AlTiC. The resulting magnetic head 30 is protected by being covered with a resist material (not shown). The substrate 40a is separated into sliders 24 by dicing. The sensor 50 is formed on surface H (the top surface of the substrate 40) of each slider 24. With respect to the formation of the sensor 50, the plurality of sliders 24 separated are aligned, and then the sensors 50 may be simultaneously formed on the plurality of the sliders 24.

### Second Embodiment

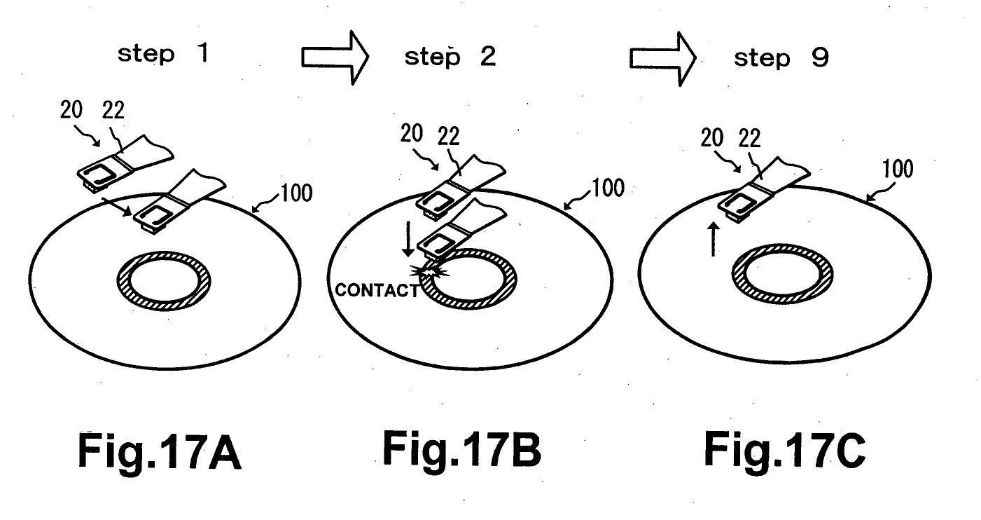

In this embodiment, the flying height of a magnetic head 30 with respect to a surface of a magnetic disk 100 is adjusted by vertically moving an arm 22 of a head unit 20. In this embodiment, the arm 22 is moved in directions of arrows shown in FIGS. 17B and 17C with a driving unit (not shown) that changes the flying height in response to energy supplied from the outside. Any of the driving unit may be used as long as it can change the amount of displacement in response to energy supplied. Examples thereof include piezoelectric elements and motors.

A magnetic disk drive 1 adjusts the flying height of the magnetic head 30 with the driving unit in the same way as in the first embodiment. The flying height of the magnetic head 30 is set at an optimum flying height with respect to the surface of the magnetic disk 100. Then a read operation or a write operation is performed. As a result, the magnetic disk drive 1 performs the read operation or the write operation while the optimum flying height of the magnetic head 30 is maintained.

What is claimed is:

1. A magnetic disk drive comprising:
a magnetic head;
a magnetic disk;
an actuator for changing the position of the magnetic head with respect to the magnetic disk;
a sensor for detecting vibration of the magnetic head; and
a controller for detecting contact between the magnetic head and the magnetic disk on the basis of the detected vibration and for controlling the actuator.

2. The magnetic disk drive according to claim 1, wherein the actuator includes a heater that thermally expands a slider having the magnetic head by being supplied with a current so as to protrude a surface of the slider facing the magnetic disk toward the magnetic disk side.

3. The magnetic disk drive according to claim 2, wherein the sensor converts the detected vibration into an electric signal, and
the controller detects the amount of current through the heater on the basis of the electric signal when the magnetic head is in contact with the magnetic disk, and then controls the flying height of the magnetic head with respect to the magnetic disk on the basis of the amount of current detected.

4. The magnetic disk drive according to any one of claim 1, wherein the contact between the magnetic head and the magnetic disk is detected on the basis of a frequency component of the detected vibration, the frequency component being maximized when the magnetic head is in contact with the magnetic disk.

5. The magnetic disk drive according to claim 4, wherein the magnetic head is determined as being in contact with the magnetic disk when a peak of the frequency component reaches a predetermined reference value.

6. The magnetic disk drive according to any one of claim 1, wherein the sensor is a piezoelectric element having a structure in which an aluminum nitride film is interposed between electrodes.

7. The magnetic disk drive according to claim 6, wherein the magnetic head is disposed on a first surface adjacent to a floating surface of the slider on which a lifting force from the magnetic disk is exerted, and
the piezoelectric element is disposed on a second surface opposite the first surface.

8. The magnetic disk drive according to claim 6, wherein the magnetic head is disposed on a first surface adjacent to a floating surface of the slider on which a lifting force from the magnetic disk is exerted, and
the piezoelectric element is disposed on a third surface opposite the floating surface.

9. A method for controlling a flying height of a magnetic head of a magnetic disk drive including the magnetic head, a magnetic disk, an actuator for changing the position of the magnetic head with respect to the magnetic disk, and a sensor for detecting vibration of the magnetic head, the method comprising:
measuring vibration of the magnetic head when the magnetic head is brought into contact with the magnetic disk;
detecting contact between the magnetic head and the magnetic disk on the basis of the measurement of vibration; and
controlling the actuator on the basis of the detection.

10. The method for controlling the flying height of a magnetic head of a magnetic disk drive according to claim 9, wherein the actuator includes a heater that thermally expands a slider by being supplied with a current so as to protrude a surface of the slider facing the magnetic disk toward the magnetic disk side.

11. The method for controlling the flying height of a magnetic head of a magnetic disk drive according to claim 10, further comprising:
converting the detected vibration into an electric signal with the sensor;
detecting the amount of current through the heater on the basis of the electric signal when the magnetic head is in contact with the magnetic disk; and
controlling the flying height of the magnetic head with respect to the magnetic disk on the basis of the amount of current detected.

12. The method for controlling the flying height of a magnetic head of a magnetic disk drive according to any one of claim 9, further comprising:
measuring a frequency component of the detected vibration, the frequency component being maximized when the magnetic head is in contact with the magnetic disk; and
detecting the contact between the magnetic head and the magnetic disk on the basis of the frequency component.

13. The method for controlling the flying height of a magnetic head of a magnetic disk drive according to claim 12, further comprising:
determining the magnetic head as being in contact with the magnetic disk when a peak of the frequency component reaches a predetermined reference value.

14. The method for controlling the flying height of a magnetic head of a magnetic disk drive according to any one of according to claim 9, wherein the sensor is a piezoelectric element having a structure in which an aluminum nitride film is interposed between electrodes.

15. The method for controlling the flying height of a magnetic head of a magnetic disk drive according to claim 14, wherein the magnetic head is disposed on a first surface adjacent to a floating surface of the slider on which a lifting force from the magnetic disk is exerted, and the piezoelectric element is disposed on a second surface opposite the first surface.

16. The method for controlling the flying height of a magnetic head of a magnetic disk drive according to claim 14, wherein the magnetic head is disposed on a first surface adjacent to a floating surface of the slider on which a lifting force from the magnetic disk is exerted, and the piezoelectric element is disposed on a third surface opposite the floating surface.
